(19) United States
(12) Patent Application Publication
(10) Pub. No.: US 2008/0119209 A1
(43) Pub. Date: May 22, 2008

(54) SELECTION OF WIRELESS COMMUNICATION CELLS BASED ON A MOBILITY STATE OF A WIRELESS DEVICE

(75) Inventor: Steven D. Upp, Bartlett, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/561,935

(22) Filed: Nov. 21, 2006

(51) Int. Cl. H04Q 7/20

(52) U.S. Cl. 455/458

(57) ABSTRACT

Disclosed are a wireless communication system, method, and information processing system for optimizing paging channel utilization. The method includes determining a mobility state of the wireless device (104). If the mobility state of the wireless device (104) is a mobile state, a signal is generated for a page to be transmitted to a set of base stations (110) in a paging area (402) that the wireless device (104) is currently located in. If the mobility state of the wireless device (104) is a stationary state, a subset of base stations from the set of base stations (110) within the paging area (402) is selected. A signal is then generated for a page to be transmitted to the subset of base stations.

### FIELD OF THE INVENTION

The present invention generally relates to the field of wireless communications, and more particularly relates to determining a set of wireless communication cells for receiving a paging signal.

### BACKGROUND OF THE INVENTION

In current wireless communication system such as an IEEE 802.16-2005 system where paging areas/location areas are comprised of multiple base stations, paging is performed to notify a wireless device of incoming data when the exact base station needed to deliver the message to is not known. Typically, in response to outbound data, a paging controller sends a paging message to all base stations in the paging area to discover which base station a wireless device is currently monitoring for outbound data. This is inefficient because many devices subscribing to the paging area may not move out of their cells or only move between a few neighboring cells that make up a subset of the overall paging area. If an outbound message is for one of these “stationary” subscribing devices, paging every cell in the paging area wastes bandwidth and decreases the efficiency of the system.

Therefore a need exists to overcome the problems with the prior art as discussed above.

### SUMMARY OF THE INVENTION

Briefly, in accordance with the present invention, disclosed are a wireless communication system, method, and information processing system for optimizing paging channel utilization. The method includes determining a mobility state of a wireless device. If the mobility state of the wireless device is determined to be mobile then a signal is generated for a page to be transmitted to the entire set of base stations in a paging area that the wireless device is currently located in. If the mobility state of the wireless device is determined to be stationary, a subset of base stations from the set of base stations within the paging area is selected. A signal is then generated for a page to be transmitted to the subset of base stations.

In another embodiment an information processing system, in a wireless communication system including stationary and mobile wireless devices, for optimizing paging channel utilization is disclosed. The information processing system includes a memory and a processor that is communicatively coupled to the memory. The information processing system also includes a paging controller that is communicatively coupled to the processor and the memory. The paging controller comprises a mobility state identifier for determining a mobility state of a wireless device. If the mobility state identifier determines that a mobility state of the wireless device is a mobile state, the paging controller generates a signal for a page to be transmitted to a set of base stations in a paging area that the wireless device is currently located in. The set of base stations is selected via a wireless communication cell selector communicatively coupled to the paging controller. If the mobility state identifier determines that the mobility state of the wireless device is a stationary state, the wireless communication cell selector selects a subset of base stations from the set of base stations within the paging area. The paging controller generates a signal for a page to be transmitted to the subset of base stations.

In yet another embodiment, a wireless communication system for optimizing paging channel utilization by a plurality of wireless devices, wherein each of the wireless devices are one of a stationary wireless device and a mobile wireless device, is disclosed. The wireless communication system includes a plurality of base stations and an information processing system that is communicatively coupled to the plurality of base stations. The information processing system is for determining a mobility state of a wireless device. If the mobility state of the wireless device is mobile, the information processing system generates a signal for a page to be transmitted to a set of base stations in a paging area that the wireless device is currently located in. If the mobility state of the wireless device is stationary, the information processing system selects a subset of base stations from the set of base stations within the paging area. The information processing system then generates a signal for a page to be transmitted to the subset of base stations.

An advantage of the foregoing embodiments of the present invention is that the paging controller selects which cells to page based on the mobility state (e.g., mobile or stationary) of the wireless device. If the device is mobile, the device must be paged on all the cells within the paging area. If the device is stationary and stays within a single cell or that cell's neighbor cells, then the paging controller only has to page this set of cells. This paging optimization reduces paging of unnecessary cells for stationary wireless devices that cannot be served by all cells in the paging area. Paging bandwidth is thereby reduced, which increases the paging capacity of the system and lets the system operator create larger paging areas. Larger paging areas reduce the number of location updates that a wireless device needs to perform as it moves through the network, thereby reducing battery load.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating an exemplary wireless communications system according to an embodiment of the present invention;

FIG. 2 is a block diagram illustrating an exemplary information processing system according to an embodiment of the present invention;

FIG. 3 is a block diagram illustrating an exemplary wireless communication device according to an embodiment of the present invention;

FIG. 4 illustrates a paging area, wherein all wireless communication cells are to receive a page for a wireless device;

FIG. 5 illustrates a paging area, wherein a subset of the wireless communication cells has been selected by a paging controller;

FIG. 6 is an operational flow diagram illustrating an exemplary process of selecting wireless communication that are to receive a paging message based on a mobility status of a wireless device according to an embodiment of the present invention;

FIG. 7 is an operational flow diagram illustrating exemplary process of determining a mobility status of a wireless device according to an embodiment of the present invention; and

FIG. 8 is an operational flow diagram illustrating exemplary process of a wireless device monitoring its mobility status according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Exemplary Wireless Communications System

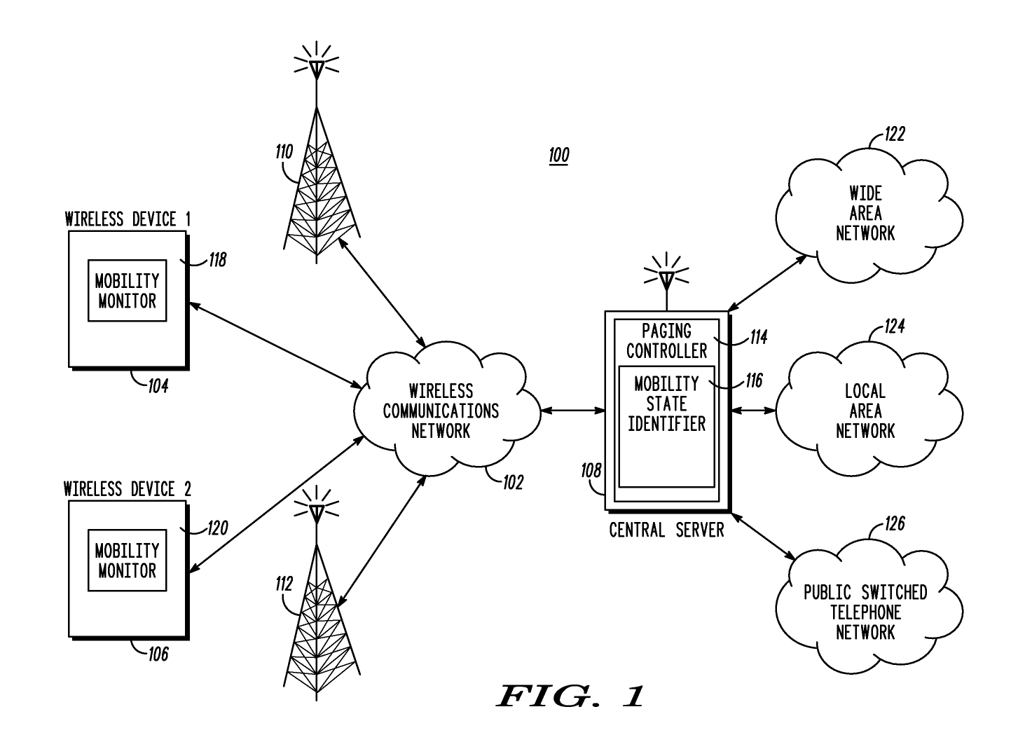

According to an embodiment of the present invention, as shown in FIG. 1, an exemplary wireless communications system 100 is illustrated. FIG. 1 shows a wireless communications network 102 that connects wireless devices 104, 106, to a central server 108. The wireless communications network 102 comprises a mobile phone network, a mobile text messaging device network, a pager network, or the like. Further, the communications standard of the wireless communications network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), Orthogonal Frequency Division Multiplexing (OFDM), or the like. Additionally, the wireless communications network 102 also comprises text messaging standards, for example, Short Message Service (SMS), Enhanced Messaging Service (EMS), Multimedia Messaging Service (MMS), or the like. The wireless communications network 102 also allows for push-to-talk over cellular communications between capable wireless communication devices.

The wireless network 102 supports any number of wireless devices 104, 106. The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities. In one embodiment, wireless communications network 102 allows for mesh networking between the wireless devices 104, 106.

The wireless communications system 100 also includes a group of base stations 110, 112. The base stations 110, 112, in one embodiment are part of a paging area. A paging area is one or more wireless communication cells that a wireless device 104, 106 can move within and not have to update its location with the central server 108. Each base station 110, 112, in one embodiment, includes a base station controller (not shown).

In an exemplary embodiment, the wireless communications network 102 is capable of broadband wireless communications such as an IEEE 802.16 system. The IEEE 802.16 standard is further described in IEEE 802.16e-2005. It should be noted that the present invention is not limited to an 802.16 system. The present invention is applicable to any wireless communication system utilizing paging areas/location areas.

The wireless communications system 100 also includes a central server 108 that maintains and processes information for all wireless devices 104, 106 communicating on the wireless network 102. Additionally, the central server 108 communicatively couples the wireless communications devices 104, 106 to one or more of a wide area network 122, a local area network 124, and a public switched telephone network 126 through the wireless communications network 102. Each of these networks has the capability of sending data, for example, a multimedia text message to the wireless devices 104, 106.

The central server 108, in one embodiment, includes a paging controller 114 for transmitting a paging signal to the paging areas. For example, the wireless devices 104, 106 are not always in an active mode where they are constantly monitoring a base station 110, 112. In one embodiment, the wireless devices 104, 106 are in an idle mode where they periodically “listen” to a paging channel for the particular cell that the device 104, 106 is located in. If the central server 108 receives outbound data for an idling wireless device 104, 106, the paging controller 114 transmits a page to the paging area that the wireless device 104, 106 is located in. This page notifies the idling device that it needs to become active to receive the data. These paging messages are transmitted on all of the base stations that make up the paging area that the device is currently within. In typical systems this comprises several base stations not all of which are in the immediate reception range of the device.

However, in one embodiment, the paging controller 114 performs “intelligent” paging. For example, in many situations the wireless device 104, 106 is stationary or stationary within the paging area as compared to being mobile. For example, if a wireless device 104, 106 does not move out of a cell for a given period of time, it can be considered stationary. In another embodiment, a wireless device 104, 106 can also be considered stationary when the device monitors the paging channel of a small set of cells within the paging area. This can occurs when a wireless device 104, 106 has marginal coverage from a subset of the cells of a paging area.

In one embodiment, the paging controller 114 includes a mobility state identifier 116 for identifying if a wireless device 104, 106 is fixed/stationary or mobile/nomadic. If the paging controller 114 determines that the wireless device is fixed/stationary, the paging controller 114, in one embodiment, sends a page to only the cell that the wireless device 104, 106 is located in (home cell) or to the home cell and its neighboring cell(s) since even a stationary device may select a neighbor of its primary home cell due to current propagation conditions. If the paging controller 114 determines that the wireless device is mobile (i.e., not stationary), a page is sent to each cell in the paging area. The paging controller 114 and the mobility state identifier 116 are described in greater detail below. It should be noted that, for purposes of the present invention, a stationary wireless device can be a device that is affixed to a particular location, such as a wall, floor, and the like or a mobile wireless device that, for a life of a session, is considered to be stationary. A mobile wireless device is explicitly allowed to move anywhere within a paging area without contacting the infrastructure when its mobility state indicates that it is mobile.

Each of the wireless devices 104, 106, in one embodiment, includes a mobility monitor 118, 120. The mobility monitor 118, 120 monitors the mobility state of the wireless device 104, 106. For example, if the wireless device 104, 106 is consistently listening to a specific base station(s) 110, 112 for a given period of time, the mobility monitor 118, 120 identifies the wireless device 104, 106 as stationary. Therefore, when the wireless device 104, 106 sends a request to the central server 108 to go idle, the device 104, 106 can also transmit its mobility state to the paging controller 114. The wireless device 104 is described in more detail below. It should be noted that in one embodiment, a stationary wireless device is defined through provisioning data. On the other hand, a mobile wireless device can determine itself that it is not moving. The wireless device 104, 106 performs this by detecting whether or not it has changed the cell it is communicating with in the recent past prior to going idle. For example, the wireless device 104, 106 may determine that in the recent past, it has maintained active communication with a single base station. When this device decides to request idle mode support from the base station 110, 112, it can inform the base station 110, 112 that it is stationary.

Otherwise, if the wireless device 104, 106 has detected recent mobility, it will inform the base station 110, 112 that it is mobile. A wireless device 104, 106 that requested idle mode and reported a mobility state of stationary may in fact begin moving. In this case, the wireless device 104, 160 may report the change in mobility state to the network and the paging controller 114 may then page the wireless device pursuant to the procedures described herein for a wireless device that is mobile. However, in the event that a wireless device 104, 106 that requested idle mode and reported a mobility state of stationary begins moving but fails to notify the network of the mobile device's changed mobility state or has not yet notified the network, and in particular the paging controller 114, of the mobile device's changed mobility state, then the paging controller may first transmit a paging message to a subset of cells in the paging area, such as the last identified home cell of the wireless device and/or to the cells that are neighbors of this cell. If a paging response is not received from this cell or cells, then the paging controller 114 may transmit a paging message to every cell in the paging area.

Exemplary Information Processing System

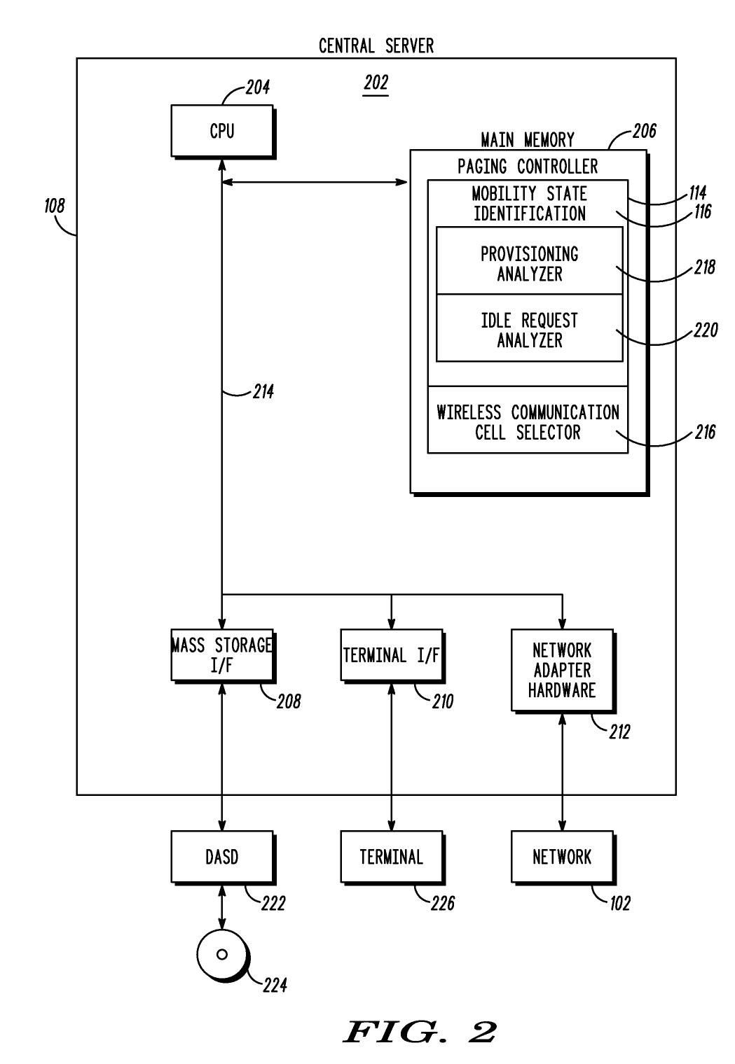

FIG. 2 is a block diagram illustrating a more detailed view of the central server 108 according to an embodiment of the present invention. The central server 108 is based upon a suitably configured processing system adapted to implement the exemplary embodiment of the present invention. Any suitably configured processing system is similarly able to be used as the central server 108 by embodiments of the present invention. For example, a personal computer, workstation, or the like, may be used. The central server 108 includes a computer 202. The computer 202 has a processor 204 that is connected to a main memory 206, a mass storage interface 208, a terminal interface 210, and network adapter hardware 212. A system bus 214 interconnects these system components. The main memory 206 includes the paging controller 114 and a wireless communication cell selector 216. Although the paging controller 114 is shown as residing in the main memory 206, it can also be implemented as a hardware component.

As described above, the paging controller 114 notifies an idling wireless device, 104, 106 that it has data to be received. When the paging controller 114 receives outbound data for a wireless device, 104, 106, it determines the mobility classification (e.g. stationary or mobile) of the device 104, 106. The mobility classification is determined, in one embodiment, by a mobility state identifier 116. The mobility classification of a wireless device 104, 106, may be conveyed to the central server 108 from either the network 102 and/or the wireless device itself 104, 106. For example, an authentication, authorization, and accounting profile associated with a wireless device 104, 106 can include provisioning data (indicating a status of stationary or mobile) that is relayed to the paging controller 114 from, for example, an 802.16 authenticator.

A provisioning analyzer 218 located in the mobility state identifier 116, in one embodiment, analyzes the provisioning data to determine if the device 104, 106 is stationary or mobile. A system operator, in one embodiment, can restrict devices 104, 106 to stationary locations and this is indicated in the provisioning data. The provisioning analyzer 218 determines if the device 104, 106 has been restricted to a stationary area and relays this information to the paging controller 114.

In another embodiment, the wireless device 104, 106, itself notifies the paging controller 114 of its mobility status. In one example, this type of device is considered stationary. For example, the wireless device 104, 106, in one embodiment, monitors the base stations it listens to and determines if it has been listening to a set of base stations for a given period of time. When the wireless device 104, 106 wants to go idle, it sends an idle request along with the identity of the cells it has been listening to, to the paging controller 114 via its current base station 110, 112. A wireless device 104, 106 may listen to one or more base stations if it is in a fringe cell coverage area and switches back and forth between two or more overlapping cells. An idle request analyzer 220 in the mobility state identifier 116 analyzes the idle request to determine of mobility status information exists. In this embodiment, the mobility status information is the identity of cells that the wireless device 104, 106 has been listening to.

If the idle request analyzer 220 determines that cell identity information exists then the mobility state identifier 114 identifies the wireless device 104, 106 as being stationary. In another embodiment, if the idle request analyzer 220 determines that mobility information such as cell identifying information does not exist in the request, the mobility state identifier 116 determines that the wireless device 104, 106 is mobile (i.e., is not stationary within a cell or a set of cells in the paging area). It should be noted that the wireless device 104, 106 is not limited to only sending cell identifying information with the idle request. The wireless device 104, 106, in one embodiment, sends cell identifying information any time before or after the idle request.

If the paging controller 114 determines that the wireless device 104, 106 is stationary, the paging controller dynamically selects a subset of all the cells in the paging area via the wireless communication cell selector 216. This subset, for example, includes the cell(s) identified from the provisioning data or the information transmitted from the wireless device 104, 106. In one embodiment, if a single cell was identified by the mobility state identifier 116 as the home cell of the idling wireless device 104, 106, the wireless communication cell selector 216 selects the home cell and its neighboring cells. If the paging controller 114 determines that the wireless device 104, 106 is mobile and is not stationary with a cell or group of cells, the wireless communication cell selector 216 selects all the cells in the paging area. The paging controller 114 then transmits a paging messaging to the cells selected by the wireless communication cell selector 216.

In another embodiment, the paging controller 114 stores the identity of the base station from which the paging controller received the idle request of the wireless device 104, 106. The paging controller 114 first transmits a paging message to this cell or to the cells that are neighbors of this cell. If a paging response is not received from this cell, the paging controller 114 then transmits a paging message to every cell in the paging area. For example, the wireless device may have been a stationary mobile device that begins moving and after it moves has either failed to notify the paging controller or has not yet notified the paging controller of its updated mobility state. By transmitting a first paging message to the mobile device's home cell or to the cells that are neighbors of this cell and then transmitting a second paging message to every cell in the paging area, the first page preserves system bandwidth while the second page provides assurances that the mobile device will be reached.

The mass storage interface 208 is used to connect mass storage devices such as data storage device 222 to the central server 108. One specific type of data storage device is a computer readable medium such as a CD drive, which may be used to store data to and read data from a CD 224. Another type of data storage device is a data storage device configured to support New Technology File System (“NTFS”) operations.

Although illustrated as concurrently resident in the main memory 206, it is clear that respective components of the main memory 206 are not required to be completely resident in the main memory 206 at all times or even at the same time. In one embodiment, the central server 108 utilizes conventional virtual addressing mechanisms to allow programs to behave as if they have access to a large, single storage entity, referred to herein as a computer system memory, instead of access to multiple, smaller storage entities such as the main memory 206 and data storage device 222. Note that the term “computer system memory” is used herein to generically refer to the entire virtual memory of the central server 108.

Although only one CPU 204 is illustrated for computer 202, computer systems with multiple CPUs can be used equally effectively. Embodiments of the present invention further incorporate interfaces that each includes separate, fully programmed microprocessors that are used to off-load processing from the CPU 204. Terminal interface 210 is used to directly connect one or more terminals 226 to computer 202 to provide a user interface to the central server 108. These terminals 226, which are able to be non-intelligent or fully programmable workstations, are used to allow system administrators and users to communicate with the central server 108. The terminal 226 is also able to consist of user interface and peripheral devices that are connected to computer 202 and controlled by terminal interface hardware included in the terminal I/F 210 that includes video adapters and interfaces for keyboards, pointing devices, and the like.

An operating system (not shown) included in the main memory is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the central server 108.

The network adapter hardware 212 is used to provide an interface to the network 102. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via CD, e.g. CD 228, floppy-disk, or other form of recordable media, or via any type of electronic transmission mechanism.

Exemplary Wireless Communication Device

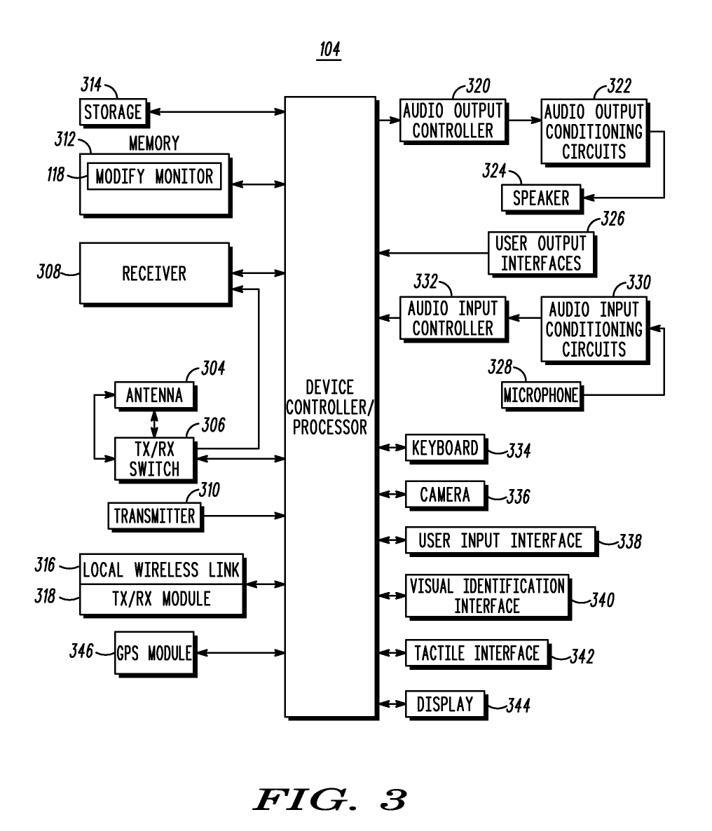

FIG. 3 is a block diagram illustrating a more detailed view of a wireless device of communication system 100. For purposes of illustrating the principles of the present invention, the wireless device 104 is described in FIG. 3. However, one of ordinary skill in the art realizes that the description below similarly applies to wireless device 106. In one embodiment, the wireless device 104 is capable of transmitting and receiving wireless information on the same frequency such as in an 802.16e system using TDD. The wireless device 104 operates under the control of a device controller/processor 302 that controls the sending and receiving of wireless communication signals. In receive mode, the device controller 302 electrically couples an antenna 304 through a transmit/receive switch 306 to a receiver 308. The receiver 308 decodes the received signals and provides those decoded signals to the device controller 302.

In transmit mode, the device controller 302 electrically couples the antenna 304, through the transmit/receive switch 306, to a transmitter 310. The device controller 302 operates the transmitter and receiver according to instructions stored in a memory 312. These instructions include, for example, a neighbor cell measurement-scheduling algorithm. These instructions also include the mobility monitor 118 that monitors the mobility status of the wireless device 104. For example, the wireless device 104 can have a mobility state of stationary. The wireless device my never leave a specific location or set of locations such as a home, office, and the like. Therefore, the cell area of the wireless device 104 is likely to not change. However, if the wireless device is consistently moving between cells, then the wireless device 104 is mobile.

The wireless device 104 is able to transmit mobility status information to the paging controller 114. For example, if the wireless device is stationary, this status can be transmitted to the paging controller along with cell identifying information. This information is used by the paging controller 114 to dynamically select a set of cells to send paging messages to. In one embodiment, the mobility status information and cell information are transmitted with an idle request. However, this information can be transmitted any time before or after an idle request is sent. If the wireless device 104 is mobile, the device 104 can either transmit this mobility status information or not transmit anything. The paging controller 114, in one embodiment, identifies the wireless device 104 as being mobile if no mobility status information is received.

The wireless device 104 also includes non-volatile storage memory 314 for storing, for example, an application waiting to be executed (not shown) on the wireless device 104. The wireless device 104, in this example, also includes an optional local wireless link 316 that allows the wireless device 104 to directly communicate with another wireless device without using the wireless network 102. The optional local wireless link 316, for example, is provided by Bluetooth, Infrared Data Access (IrDA) technologies, or the like. The optional local wireless link 316 also includes a local wireless link transmit/receive module 318 that allows the wireless device 104 to directly communicate with another wireless communication device.

The wireless device 104 of FIG. 3 further includes an audio output controller 320 that receives decoded audio output signals from the receiver 308 or the local wireless link transmit/receive module 318. The audio controller 320 sends the received decoded audio signals to audio output conditioning circuits 322 that perform various conditioning functions. For example, the audio output conditioning circuits 322 may reduce noise or amplify the signal. A speaker 324 receives the conditioned audio signals and allows audio output for listening by a user. The audio output controller 320, audio output conditioning circuits 322, and the speaker 324 also allow for an audible alert to be generated notifying the user of a missed call, received messages, or the like. The wireless device 104 further includes additional user output interfaces 326, for example, a head phone jack (not shown) or a hands-free speaker (not shown).

The wireless device 104 also includes a microphone 328 for allowing a user to input audio signals into the wireless device 104. Sound waves are received by the microphone 328 and are converted into an electrical audio signal. Audio input conditioning circuits 330 receive the audio signal and perform various conditioning functions on the audio signal, for example, noise reduction. An audio input controller 332 receives the conditioned audio signal and sends a representation of the audio signal to the device controller 302.

The wireless device 104 also comprises a keyboard 334 for allowing a user to enter information into the wireless device 104. The wireless device 104 further comprises a camera 336 for allowing a user to capture still images or video images into memory 312. Furthermore, the wireless device 104 includes additional user input interfaces 338, for example, touch screen technology (not shown), a joystick (not shown), or a scroll wheel (not shown). In one embodiment, a peripheral interface (not shown) is also included for allowing the connection of a data cable to the wireless device 104. In one embodiment of the present invention, the connection of a data cable allows the wireless device 104 to be connected to a computer or a printer.

A visual notification (or indication) interface 340 is also included on the wireless device 104 for rendering a visual notification (or visual indication), for example, a sequence of colored lights on a display 344 included in the wireless device or flashing one or more LEDs (not shown), to the user of the wireless device 104. For example, a received multimedia message may include a sequence of colored lights to be displayed to the user as part of the message. Alternatively, the visual notification interface 340 can be used as an alert by displaying a sequence of colored lights or a single flashing light on the display 344 or LEDs (not shown) when the wireless device 104 receives a message, or the user missed a call.

The wireless device 104 also includes a tactile interface 342 for delivering a vibrating media component, tactile alert, or the like. For example, a multimedia message received by the wireless device 104, may include a video media component that provides a vibration during playback of the multimedia message. The tactile interface 342, in one embodiment, is used during a silent mode of the wireless device 104 to alert the user of an incoming call or message, missed call, or the like. The tactile interface 342 allows this vibration to occur, for example, through a vibrating motor or the like.

The wireless device 104 also may include an optional Global Positioning System (GPS) module 346. The optional GPS module 346 determines the location and/or velocity information of the wireless device 104. This module 346 uses the GPS satellite system to determine the location and/or velocity of the wireless device 104. Alternative to the GPS module 346, the wireless device 104 may include alternative modules for determining the location and/or velocity of wireless device 104, for example, using cell tower triangulation and assisted GPS.

Do we need to note that other positioning services could be used? The above paragraph is speaking specifically about the US DOD system. There is a Russian system on the air now and I believe a European one in the works.

Example of a Mobile and Stationary Wireless Device

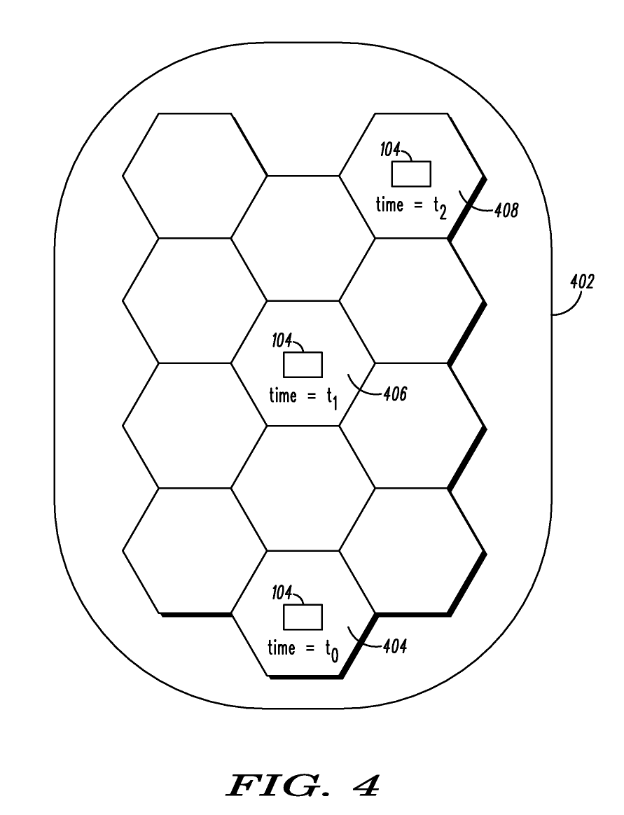

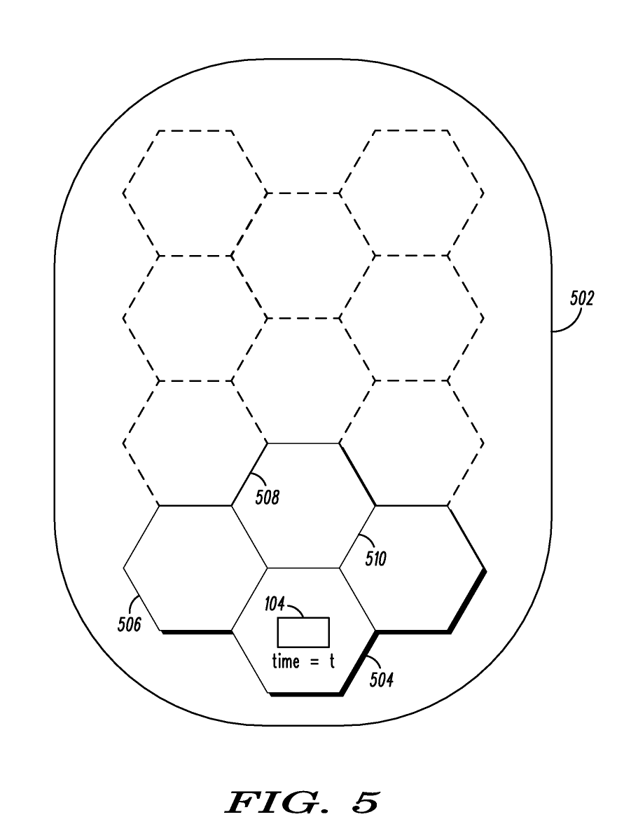

FIG. 4 and FIG. 5 respectively depict examples of the wireless device 104 when in a mobile state and a stationary state and a corresponding selection of cells for a receiving of a paging message. FIG. 4 shows a group of cells in a paging area 402. Although only cells within the paging area 402 are shown, cells can overlap into other paging areas as well. In FIG. 4, the wireless device 104 is in a first cell 404 at time t₀. At time t₁ the wireless device has moved into a second cell 406 and at time t₂ the wireless device 104 has moved into a third cell 408. Therefore, the mobility monitor 118 of the wireless device 104 and the paging controller 114 in the central server 108 identify the wireless device 104 as being mobile. As the mobile device is identified as being mobile, all of the cells in the paging area 402 are selected to receive a paging messaging to notify the idling wireless device 104 of an incoming message.

FIG. 5 shows a group of cells in a paging area 502. In FIG. 5, the wireless device 104 remains within a single cell 504. Therefore, the mobility monitor 118 of the wireless device 104 and the paging controller 114 in the central server 108 identify the wireless device 104 as being stationary. Accordingly, the paging controller 114 only selects the cell 504 in which the device 104 is stationary in to receive the paging message. In another embodiment, the neighboring cells 506, 508, 510 of the device's current cell are also selected to receive the page. The cells with dashed lines indicate that the cells have not been selected. In yet another embodiment, the wireless device 104 may also be identified as stationary if it moves between a subset of the cells in the paging area 502, for example, among cells 504, 506, 508, and 510, in which event the subset of cells, and possibly one or more neighboring cells, are selected to receive the page.

This paging optimization reduces paging unnecessary cells for stationary wireless devices that cannot be served by all cells in the paging area. Paging bandwidth is thereby reduced, which increases the efficiency of the paging capacity of the system and lets the system operator created larger paging areas. Larger paging areas reduce the number of location updates that a wireless device needs to perform as it moves through the network thereby reducing battery load.

Exemplary Processes of Selecting Cells Based on Mobility Status

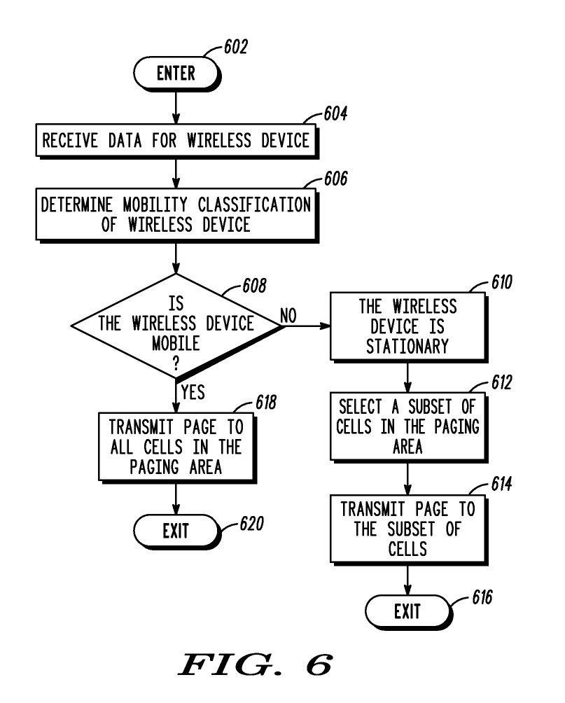

FIG. 6 is an operational flow diagram illustrating an exemplary process of selecting wireless communication cells to receive a paging message. The operational flow diagram of FIG. 6 begins at step 602 and flows directly to step 604. The central server 108, at step 604, receives outbound data for a wireless device 104, 106. The paging controller 114, at step 606, determines the mobility classification of the wireless device 104, 106. For example, the paging controller 114 uses information transmitted from the network 102 or the wireless device such as cell identifying information to determine the mobility classification of the device 104, 106.

Based upon the mobility information (or lack of information), the paging controller 114, at step 608, determines if the wireless device 104, 106 is mobile. If the result of this determination is negative, the wireless device is determined, at step 610, to be stationary. When the wireless device is determined to be stationary, the paging controller 114, at step 612, selects a subset of cells in the paging area. For example, based on provisioning data received or from cell identifying information received, the paging controller 114 selects the cell that the device 104, 106 is currently in. In another embodiment, this subset of cells also includes the neighboring cells of the current cell. The paging controller 114, at step 614, transmits a paging message to the subset of cells. The control flow then exits at step 616. If the determination at step 608 is positive, that is, the wireless device is determined to be mobile, the paging controller 114, at step 618, transmits a paging message to all of the cells in the paging area. The control flow then exits at step 620.

Exemplary Processes of Determining Mobility Status

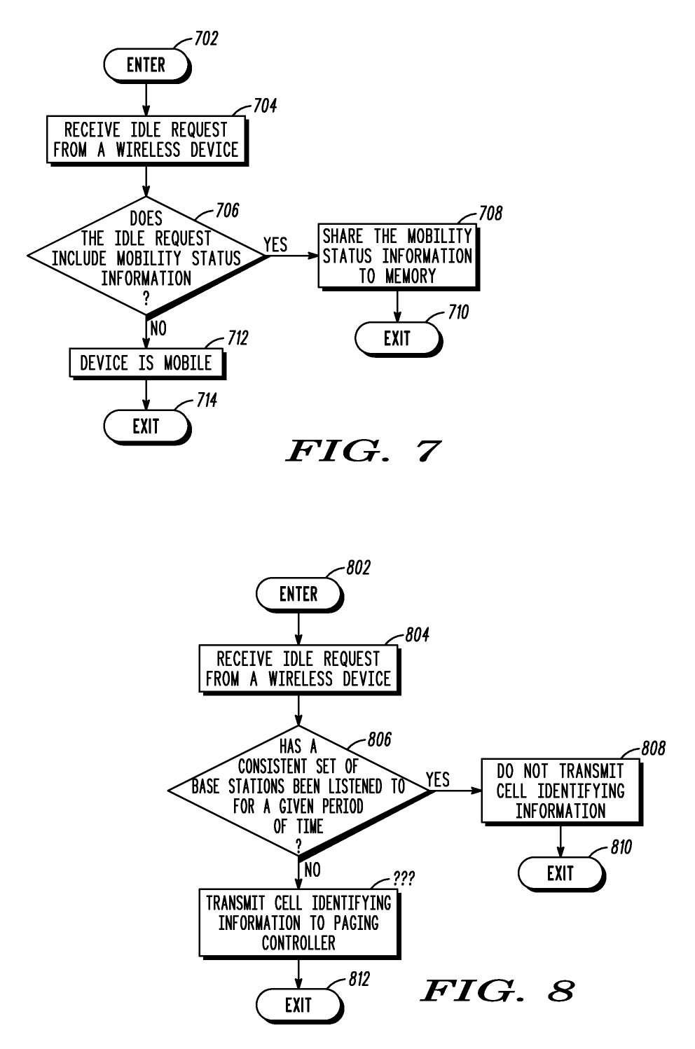

FIG. 7 is an operational flow diagram illustrating an exemplary process of determining the mobility status of a wireless device 104, 106. The operational flow diagram of FIG. 7 begins at step 702 and flows directly to step 704. The paging controller 114, at step 704, receives an idle request from a wireless device 104, 106. The paging controller 114, at step 706, determines if the idle request includes mobility status information. For example, mobility status information can include cell identifying information that identifies a set of cells that the device 104, 106 has been consistently in for a given period of time.

When the idle request includes mobility status information, the paging controller 114, at step 708, stores the mobility status information (e.g. the cell identifying information) in memory 206. This information is used to select a subset of cells that is to receive a paging message. The control flow then exits at step 710. When the idle request does not include mobility status information, the device is determined to be mobile at step 712. In this situation, the paging controller 114 transmits a paging message to every cell in the paging area. The control flow then exits at step 714.

Exemplary Process of a Wireless Device Monitoring its Mobility Status

FIG. 8 is an operational flow diagram illustrating an exemplary process of the wireless device 104, 106 monitoring its mobility status. The operational flow diagram of FIG. 8 begins at step 802 and flows directly to step 804. The wireless device 104, 106, at step 804, monitors the base stations it “listens” to. For example, every time the wireless device 104, 106 switches cells, it records this change. The wireless device 104, 106, at step 806, determines if a consistent set of base stations 110, 112 have been “listened” to for a given period of time. If the result of this determination is positive, mobility status information, such as cell identifying information, is transmitted (811) to the paging controller 114.

For example, if a set of base stations have been consistently “listened” to, the wireless device 104, 106 is likely stationary. Therefore, the wireless device 104, 106 transmits mobility status information to the paging controller 114 so that only this set of cells needs to be paged when the device 104, 106 is idle. The control flow then exits at step 812. If the result of the determination at step 806 is negative, the device 104, 106 is likely mobile does not transmit (808) mobility status information to the paging controller 114. The control flow then exits at step 810.

### NON-LIMITING EXAMPLES

The foregoing embodiments of the present invention are advantageous because they provide dynamic optimization of the resources available to wireless communication information to wireless communication devices using unicast broadcast/multicast communication modes. Information can be wireless communicated to a wireless communication device in a more manner thereby optimizing network resources. A further advantage is that a base-station controller controls the switching between wireless communication modes. The wireless communication mode is based on the number of time-slots needed to transmit requested data. Another advantage is that the base station controller prepares wireless communication devices for a communication mode prior to a hand-off event thereby minimizing transmission gaps when crossing seams.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, in a wireless communication system including stationary and mobile wireless devices, for optimizing paging channel utilization, the method comprising:
determining a mobility state of a wireless device;
if the mobility state of the wireless device is a mobile state,
generating a signal for a page to be transmitted to a set of base stations in a paging area that the wireless device is currently located in; and
if the mobility state of the wireless device is a stationary state,
selecting a subset of base stations from the set of base stations within the paging area, and
generating a signal for a page to be transmitted to the subset of base stations.

2. The method of claim 1, wherein the subset of base stations includes a base station for a home wireless communication cell and at least one base station for a wireless communication cell neighboring the home wireless communication cell.

3. The method of claim 1, wherein the determining the mobility state further comprises at least one of:
receiving an authentication, authorization, and accounting profile associated with the wireless device including provisioning data; and
receiving an idle state request from the wireless device including the mobility state of the wireless device.

4. The method of claim 3, wherein the determining the mobility state further includes receiving an identification of at least one base station that the wireless device is currently communicating with.

5. The method of claim 1, wherein the generating a signal for a page to be transmitted to the subset of base stations further comprises:
transmitting the page to the subset of base stations;
determining if a paging response has been received from the wireless device; and
transmitting, in response to a lack of a paging response being received, the page to each base station in the paging area.

6. An information processing system, in a wireless communication system including stationary and mobile wireless devices, for optimizing paging channel utilization, the information processing system comprising:
a memory;
a processor communicatively coupled to the memory; and
a paging controller communicatively coupled to the processor and the memory, the paging controller comprising:
a mobility state identifier for determining a mobility state of a wireless device;
wherein if the mobility state identifier determines that a mobility state of the wireless device is a mobile state, the paging controller generates a signal for a page to be transmitted to a set of base stations in a paging area that the wireless device is currently located in, wherein the set of base stations is selected via a wireless communication cell selector communicatively coupled to the paging controller, and
wherein if the mobility state identifier determines that the mobility state of the wireless device is a stationary state, the wireless communication cell selector selects a subset of base stations from the set of base stations within the paging area, and the paging controller generates a signal for a page to be transmitted to the subset of base stations.

7. The information processing system of claim 6, wherein the subset of base stations includes a base station for a home wireless communication cell and at least one base station for a wireless communication cell neighboring the home wireless communication cell.

8. The information processing system of claim 6, wherein the mobility state identifier determines the mobility by at least one of:
receiving an authentication, authorization, and accounting profile associated with the wireless device including provisioning data; and
receiving an idle state request from the wireless device including the mobility state of the wireless device.

9. The information processing system of claim 8, wherein the mobility state identifier further determines the mobility by receiving an identification of at least one base station that the wireless device is currently communicating with.

10. The information processing system of claim 6, wherein the generating the signal for the page to be transmitted to the subset of base stations further comprises:
transmitting the page to the subset of base stations;
determining if a paging response has been received from the wireless device; and
transmitting, in response to a lack of a paging response being received, the page to each base station in the paging area.

11. A wireless communication system for optimizing paging channel utilization by a plurality of wireless devices, wherein each of the wireless devices is one of a stationary wireless device and a mobile wireless device, the wireless communication system comprising:
a plurality of base stations;
an information processing system communicatively coupled to the plurality of base stations, wherein the information processing system is for:
determining a mobility state of a wireless device;
if the mobility state of the wireless device is a mobile state,
generating a signal for a page to be transmitted to a set of base stations in a paging area that the wireless device is currently located in; and
if the mobility state of the wireless device is a stationary state,
selecting a subset of base stations from the set of base stations within the paging area, and
generating a signal for a page to be transmitted to the subset of base stations.

12. The wireless communication system of claim 11, wherein the subset of base stations includes a base station for a home wireless communication cell and at least one base station for a wireless communication cell neighboring the home wireless communication cell.

13. The wireless communication system of claim 11, wherein the determining, by the information processing system, the mobility state further comprises at least one of:
receiving an authentication, authorization, and accounting profile associated with the wireless device including provisioning data; and
receiving an idle state request from the wireless device including the mobility state of the wireless device.

14. The wireless communication system of claim 13, wherein the determining, by the information processing system, the mobility state further includes receiving an identification of at least one base station that the wireless device is currently communicating with.

15. The wireless communication system of claim 11, wherein the generating, by the information processing system, a signal for a page to be transmitted to the subset of base stations further comprises:
transmitting the page to the subset of base stations;
determining if a paging response has been received from the wireless device; and
transmitting, in response to a lack of a paging response being received, the page to each base station in the paging area.
